(19) United States
(12) Patent Application Publication
(10) Pub. No.: US 2010/0031669 A1
(43) Pub. Date: Feb. 11, 2010

(54) Free Turbine Generator For Aircraft

(75) Inventor: Thomas Ensign, Wichita, KS (US)

Correspondence Address: LATHROP & GAGE LLP, 2345 GRAND Boulevard, SUITE 2400, KANSAS CITY, MO, 64108, US

(73) Assignee: Cessna Aircraft Company

(21) Appl. No.: 12/248,639

(22) Filed: Oct. 9, 2008

Related U.S. Application Data
(60) Provisional application No. 61/086,700, filed on Aug. 6, 2008.

(51) Int. Cl. F02C 6/04; F01B 25/02

(52) U.S. Cl. 60/784; 415/148

(57) ABSTRACT

A turbine engine for an aircraft is disclosed. The turbine includes a turbine generator which is not connected to the low or high pressure spools of the turbine engine. The generator is used to create power for use in electrical systems in the aircraft. In some embodiments, the free-turbine airfoils receive the core air through an array of variable-pitch vanes. The pitch of these vanes is alterable to control the core air so that the speed of the free turbine remains substantially constant even though engine speed fluctuates.

### CROSS-REFERENCE TO RELATED APPLICATIONS

This application claims the benefit of U.S. Provisional Patent Application No. 61/086,700 filed Aug. 6, 2008, the disclosure of which is incorporated herein by reference.

### BACKGROUND OF THE INVENTION

1. Field of the Invention

The disclosures herein relate generally to the field of aircraft turbine engine designs. Additionally, these disclosures relate to the field of providing electrical power for aircraft.

2. Description of the Related Art

The need for thrust in a jet aircraft is provided using one or more turbine engines. Subsystems in the modern aircraft, however, also require power. For example, the HVAC systems in the cockpit and cabin, the deicing equipment, and other systems must be powered in some fashion. Historically, the electrical power needed has been generated using mechanical energy and/or compressed air (e.g., bleed air) derived from the turbine engine. Electrical power has also been provided using a generator which is mechanically linked to one of the high or low pressure spools. Because of the wide range of speeds at which these spools rotate in the operation of the engines, power conditioning units are necessary in order to maintain the electricity produced into voltages and frequencies which are useful.

### SUMMARY

The present invention is defined by the claims below. Embodiments of the disclosed systems and methods include a turbine engine for an aircraft. The aircraft engine includes an array of airfoils which receive airflow in the turbine engine and create electrical power for use in the aircraft's electrical systems. The free-turbine is not mechanically linked to the low or high pressure spools of the turbine engine, and in embodiments, rotates independently of these. In some embodiments, the free-turbine airfoils receive the core air through an array of variable-pitch vanes. The pitch of these vanes is alterable for different engine speeds. This enables the engine to maintain the free turbine at a substantially constant speed even when the aircraft engine speed or electrical demand fluctuates.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a view of an aircraft turbine engine incorporating a free-turbine generator according to one embodiment.

### DETAILED DESCRIPTION

Embodiments of the present invention provide systems and methods for generating electrical, or other power in an aircraft. A free turbine—one not mechanically linked or connected to any of the driving machinery of the aircraft engine—is used to generate electrical or other power. This grants multidisciplinary benefits to the engine and aircraft overall.

A recent trend in aviation is to power all aircraft systems with electricity, rather than a combination of mechanical, compressed air, and electric power, as is currently the case. This greatly increases the electrical power demanded of the turbine engine. Several alternative arrangements of generators on turbine engines have been proposed, but have proven unsatisfactory. These prior art versions typically involve driving one or more generators directly from the high pressure and/or low pressure spools. Since the rotational speed of these engine parts change with throttle setting, altitude, and airspeed, so does the voltage, frequency, and current capacity of the electrical power generated from them. This variation in parameters has made it necessary for the designer to incorporate a relatively large, heavy, complicated, and expensive power conditioning unit (PCU) so that the electrical power generated is converted into a usable voltage and frequency.

Generating large amounts of electrical power from the high pressure and/or low pressure spools introduces several problems for the engine designer, which may have a negative effect on cost, versatility, and operating characteristics of the engine.

This disclosure presents an arrangement wherein electric power is generated utilizing the airflow through the turbine engine. Since the generator in this arrangement is not mechanically linked to the high and low pressure spools, the aforementioned complications are eliminated or greatly reduced. Furthermore, the free turbine generator is optionally designed to rotate at a fixed speed, independent of the remainder of the engine. Because of this, the weight and efficiency of the generator may be optimized, and a power conditioning unit is unnecessary.

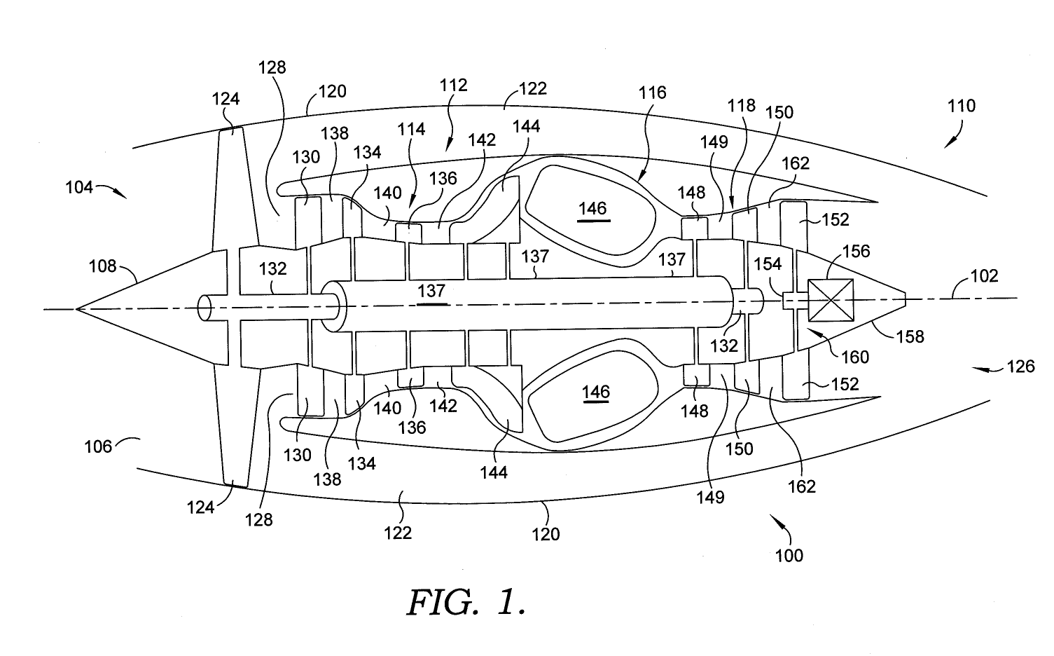

One embodiment for the system is disclosed in FIG. 1. FIG. 1 is a cross-sectional view of a turbofan engine 100 incorporating a free turbine as already summarized above. The engine is symmetrical about a longitudinal center axis 102. At a forward end 104 is an air inlet 106 where air is received in around an inlet cone 108. From the forward end 104 to an aft end 110, a core assembly 112 which includes a compressor section 114, a combustion section 116, and a turbine section 118 is all included within an outer casing 120.

For a turbofan engine, air received into the turbine engine 100 is divided into two distinct flows. A first flow is received from a fan 124 into a bypass duct 122 which is created between the inner assembly 112 and the outer casing 120. This airflow is referred to as the “bypass air.” Duct 122 is used to thrust air received from a fan 124 around the combustor assembly 112 and out of an exit opening 126 at the aft end 110. A second flow is received from a fan 124 into a mouth 128 of the core assembly for involvement in the combustion process, and is referred to as the “core air.”

Air received into mouth 128 will be compressed using a series of compressor blade stages working in cooperation with a plurality of corresponding stators. A first stage of compressor blades 130 are mechanically linked to, and rotate with a low pressure spool 132 along with fan 124. A second set 134 and a third set 136 of compressor blades, however, are mechanically linked to, and rotate with a high pressure spool 137. High pressure spool 137 rotates freely from low pressure spool 132. Fixed to combustor assembly, a plurality of stator sets 138, 140, and 142 cooperate with compressor blade sets 134, 136, and 138 respectively to dramatically compress the air received. Thereafter, the air may be directed into a centrifugal compressor 144.

Now greatly compressed, the air is presented into a combustion chamber 146 and ignited. Once combusted, the products are expelled under extreme pressure into a first stage of turbine airfoils 148 which are fixed to and rotate with high pressure spool 137. A second stage of turbine airfoils 150 are connected to and rotate with low pressure spool 132. A set of stationary stator blades 149 exists between these stages as shown. Stages 148 and 150 drive spools 137 and 132 respectively, and thus cause the turbine to create thrust for the aircraft.

Additionally, a free-turbine generator arrangement 160 comprising an array or airfoils 152, an independently rotating shaft 154, and an electric generator 156 (which converts the mechanical energy into electrical energy) is included in the engine. It is important to note that it is possible that the free-turbine generator could be located at other positions in the engine (e.g., forward end 104, other locations in the path of the core air, adapted to receive the bypass air in passageway 122) and still fall within the scope of the invention. Thus, the precise location of the free-turbine generator should not be considered limiting unless specifically claimed. In the disclosed embodiment, the free-turbine generator arrangement is located at the aft end of the engine 110. The free-turbine airfoils 152, in the FIG. 1 embodiment, are located just forward of a rear nozzle 158. Also in the FIG. 1 embodiment, the generator is fixed inside rear nozzle 158. As can be seen in the FIGURE, the turbine generator arrangment 160 is not mechanically connected to either low pressure spool 132 or high pressure spool 137. Thus, generator turbine airfoils 152 and shaft 154 are free to rotate independently from the remainder of the engine. Airfoils 152 extract energy from the hot air rushing out of the nozzle of the engine, and this energy is used to drive generator 156, and ultimately, the systems of the aircraft. In other embodiments, the electric generator may be replaced with one or more mechanically driven, power producing devices. For example, one or more hydraulic pumps, air compressors, or combinations thereof could be used instead.

In some embodiments, nonrotating turbine blades (e.g., stators) could be located in a location 162 between the low pressure spool and the free turbine (not shown in the diagram). The pitch angle of these variable-pitch stator blades can be varied using automated systems as necessary to force the free turbine airfoil stage 152 to rotate at a constant speed without reacting to increases and decreases in turbine speeds. Alternatively, the airfoil blades in stage 152 might be adapted to accomplish dynamic pitch changes to control rotational speed and thus the voltage and frequency of produced. These arrangments are made possible because the free-turbine is not mechanically tied to the spools. Rather than an electric generator, such a mechanism could be used to drive other power sources (i.e. hydraulic pump, or air compressor) to operate at a constant or controlled (but variable) speed.

It should be understood that although the embodiment of FIG. 1 and described herein is that of a “turbofan” engine, which is the most common type of jet engine in modern aircraft, the disclosed technologies would also be applicable to turbojet engines which are essentially the same as a turbofan engine, except without a fan 124, bypass duct 122, and outer casing 120. Further, some turbofan and turbojet engines differ from FIG. 1 in the number and arrangement of compressor and turbine stages. Finally, embodiments may include a variety in the shape, number, and arrangement of the combustion chamber(s). Those skilled in the art will recognize that systems like the free-turbine arrangement 160 used herein could be used in numerous other turbine arrangements as well.

The free turbine generator offers numerous advantages for future aircraft with large electrical power demand. Fluctuations in electrical demand will affect the engines with free turbine generators; a free turbine generator allows the engines to be designed for optimal efficiency and operating characteristics. This optimization will result in the free-turbine generator that costs and weighs less than the conventional spool-connected generator arrangement which requires the combination of a generator and an accessory gearbox. Further, the aircraft electrical system cost and weight can be reduced without the need for a power conditioning unit, the need for which is eliminated by the ability to maintain the speed of the free-turbine generator such that power output is substantially constant. Additionally, the free-turbine generator can provide significantly much more electrical power than can be provided from generators attached to either the high or low pressure spools.

Again, the free turbine generator might be placed anywhere along the centerline of the turbine engine, from the inlet to the nozzle. This disclosure does not necessarily limit the placement to a single location. However, there are several advantages to placing it in the aft end of the engine, as shown in FIG. 1. One advantage is that the airflow in this area has more energy to impart to the turbine, compared to airflow in the inlet, fan duct, compressor, and nozzle, allowing the turbine to be smaller and lighter. Further, the core airflow at suggested aft-end location exists at lower temperatures than at other locations within the turbine section of the engine, allowing the free turbine generator to be made of lighter and less costly materials. Additionally, locating the free turbine generator at the aft end 110 (or possibly the front end 104) of the engine allows it to be easily accessed for maintenance.

Because the free turbine can be added to the aft end of the engine with little or no modifications to the remainder of the engine, the engine manufacturer can retrofit free turbine assembly 160 into existing engine versions by making the proper adaptations. Also possible, of course, is that the free-turbine assembly 160 could be originally designed into and then manufactured at the same time as the engine 100. Regardless, the retrofitting option will increase production opportunities, and allow for cost savings to the airframer.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. An engine for an aircraft incorporating a turbine system comprising:
a power-supply arrangement, said arrangement comprising a stage of airfoils disposed in a location such that said airfoils are dynamically engaged by a source of airflow in the turbine engine to cause said airfoils to rotate about a shaft and thus create mechanical energy in said shaft;
a power conversion device for converting the mechanical energy in said shaft into a useful energy source for the purpose of operating at least one power-consuming subsystem in the aircraft;
said stage of airfoils and said shaft rotating independently from all of the turbine-driving and thrust-producing shafts in the engine; and
said engine being adapted such that it primarily produces thrust by forcing air through at least one nozzle.

2. The engine of claim 1 comprising wherein said engine is one of a turbofan and a turbojet.

3. The engine of claim 1 wherein said power conversion device comprises an electrical generator, and said power-consuming subsystem comprises at least one electricity-consuming device.

4. A gas-powered turbine engine comprising:
a free turbine, said free turbine including a plurality of blades, said free turbine receiving a source of air through an array of variable-pitch vanes, said pitch being alterable to control the angular velocity of said free turbine at a substantially constant speed even when one of said engine speed or electrical power demand fluctuates;
means to convert mechanical energy from said free turbine into a source of power to operate a system in an aircraft;
said engine being adapted such that its primary energy production is of thrust by forcing air through at least one nozzle to propel said aircraft.

5. The engine of claim 4 incorporated into one of a turbofan and a turbojet.

6. A gas-powered turbine engine comprising:
a free turbine, said free turbine including a plurality of blades;
said free turbine receiving a source of air through an array of corresponding vanes;
one of said plurality of blades and said plurality of vanes being pitch-alterable in order to enable said free turbine to operate at a substantially constant angular velocity when one of said engine speed or electrical power demand fluctuates;
means to convert mechanical energy from said free turbine into a source of power to operate a system in an aircraft; and
said engine being adapted such that its primary energy production is of thrust by forcing air through at least one nozzle to propel said aircraft.

7. The gas-powered turbine engine of claim 6 wherein said free turbine has a shaft which rotates independently from all of the turbine-driving and thrust-producing shafts in the engine.

8. The gas-powered turbine engine of claim 6 wherein gas-powered turbine engine is an aircraft engine.

9. The gas-powered turbine engine of claim 6 wherein said gas-powered turbine engine primarily produces thrust by forcing air through a nozzle.
